(19) United States
(12) Patent Application Publication
(10) Pub. No.: US 2026/0167210 A1
(43) Pub. Date: Jun. 18, 2026

(54) DISTANCE-ADAPTIVE SENSOR FUSION METHOD, VEHICLE, AND COMPUTER-READABLE STORAGE MEDIUM STORING INSTRUCTIONS FOR PERFORMING DISTANCE-ADAPTIVE SENSOR FUSION METHOD

(71) Applicants: Hyundai Motor Company, Seoul (KR); Kia Corporation, Seoul (KR)

(72) Inventors: Da Ye OH, Hwaseong-Si (KR); Jun Hyung KIM, Hwaseong-Si (KR); Jun Ho KOH, Hwaseong-Si (KR)

(21) Appl. No.: 19/421,274

(22) Filed: Dec. 16, 2025

(30) Foreign Application Priority Data
Dec. 17, 2024 (KR) 10-2024-0188920

(51) Int. Cl. B60W 50/06; B60W 60/00; G01S 13/86; G01S 13/931; G01S 15/931; G06V 10/25; G06V 10/44; G06V 10/77; G06V 10/80; G06V 20/58

(52) U.S. Cl. CPC B60W 50/06; B60W 60/0015; G01S 13/862; G01S 13/867; G01S 13/931; G01S 15/931; G06V 10/25; G06V 10/44; G06V 10/7715; G06V 10/806; G06V 20/58; B60W 2420/403; B60W 2420/408; G01S 2013/9314; G01S 2013/93185; G06V 2201/08

(57) ABSTRACT

There is provided a distance-adaptive sensor fusion method. The method comprises determining radar feature information using a radar signal; determining radar bird's-eye-view (BEV) feature information based on the radar feature information; determining ultrasonic feature information using an ultrasonic signal; determining ultrasonic BEV feature information based on the ultrasonic feature information; determining image feature information using image information; reflecting depth information of the radar feature information and the ultrasonic feature information in the image feature information in consideration of a detection area of a radar sensor and a detection area of a ultrasonic sensor, and performing view transformation on the image feature information; constructing image BEV feature information based on the image feature information on which the view transformation is performed; and concatenating the radar BEV feature information, the ultrasonic BEV feature information, and the image BEV feature information to determine a fused BEV feature information map.

### CROSS-REFERENCE TO RELATED APPLICATION

This application claims the benefit of priority to Korean Patent Application No. 10-2024-0188920, filed in the Korean Intellectual Property Office on Dec. 17, 2024, the disclosure of which is incorporated herein by reference in its entirety.

### TECHNICAL FIELD

The disclosed disclosure relates to a vehicle and a control method therefor, and more specifically, to sensor fusion technology.

### BACKGROUND

The matters described in this Background section are only for enhancement of understanding of the background of the disclosure, and should not be taken as acknowledgment that they correspond to prior art already known to those skilled in the art.

An autonomous vehicle may recognize a road environment by itself, determine a driving situation, and move from a current location to a target location along a planned driving path.

In this case, the autonomous vehicle may use a sensor fusion device, and the sensor fusion device may allow other vehicles, obstacles, and roads to be recognized through a combination of various sensors such as a camera, radar, and lidar.

To this end, signals or data detected through various sensors may be fused, but since detection distances and characteristics of recognized data are different depending on types of sensors, various attempts are being made to fuse signals or data detected through various sensors.

### SUMMARY

The disclosed disclosure is directed to providing a method and a vehicle capable of improving the performance in detection of an object from an image by reflecting depth information of data from an ultrasonic sensor and a radar sensor in a camera image.

Further, the disclosed disclosure is directed to providing a method and a vehicle capable of maximizing the performance of object recognition according to a situation by reflecting a weight map considering detection areas of an ultrasonic sensor and a radar sensor in detection of an object in an image.

According to the present disclosure, a method performed by a vehicle may comprise obtaining radar feature information using a radar signal input from a radar sensor of the vehicle, determining radar bird's-eye-view feature information based on the radar feature information, obtaining ultrasonic feature information using an ultrasonic signal input from an ultrasonic sensor of the vehicle, determining ultrasonic bird's-eye-view feature information based on the ultrasonic feature information, obtaining image feature information using image data captured from a camera of the vehicle, updating the image feature information based on first depth information associated with a first detection area of the radar sensor and second depth information associated with a second detection area of the ultrasonic sensor, performing view transformation on the updated image feature information, determining image bird's-eye-view feature information based on the view-transformed image feature information, outputting, based on fusion of the radar bird's-eye-view feature information, the ultrasonic bird's-eye-view feature information, and the image bird's-eye-view feature information, a signal indicating detected objects, and controlling an operation of the vehicle based on the signal.

The method may further include determining a radar weight map by assigning, to regions within the first detection area, a first weight higher than weights assigned to regions outside the first detection area, determining an ultrasonic weight map by assigning, to regions within the second detection area, a second weight higher than weights assigned to regions outside the second detection area, and determining a camera-image weight map by assigning, to regions within a third detection area of the camera, a uniform weight having a value between the first weight and the second weight, wherein the signal indicating the detected objects may include a fused bird's-eye-view feature information map. The method may further include generating a radar weight map by assigning a weight to the first detection area of the radar sensor, adjusting weight values of portions of the radar bird's-eye-view feature information associated with the first detection area based on the radar weight map, determining a radar bird's-eye-view feature information map based on the adjusted values, generating an image weight map by assigning a weight to a third detection area of the camera, adjusting weight values of portions of the image bird's-eye-view feature information associated with the third detection area based on the image weight map, determining an image bird's-eye-view feature information map based on the adjusted values, generating an ultrasonic weight map by assigning a weight to the second detection area of the ultrasonic sensor, adjusting weight values of portions of the ultrasonic bird's-eye-view feature information associated with the second detection area based on the ultrasonic weight map, determining an ultrasonic bird's-eye-view feature information map based on the adjusted values, and determining a fused bird's-eye-view feature information map based on fusion of the radar bird's-eye-view feature information map, the image bird's-eye-view feature information map, and the ultrasonic bird's-eye-view feature information map.

The method may include assigning a maximum weight value to pixels included in the first detection area of the radar sensor and a minimum weight value to pixels outside the first detection area, and assigning a maximum weight value to pixels included in the second detection area of the ultrasonic sensor and a minimum weight value to pixels outside the second detection area. The method may include determining the camera-image weight map by assigning a weight value smaller than a maximum weight value and greater than a minimum weight value to pixels included in the third detection area of the camera. The method may define the first detection area of the radar sensor as a region extending 4 meters to less than 100 meters from an outer surface of the vehicle, define the second detection area of the ultrasonic sensor as a region extending 0.2 meters to less than 4 meters from the outer surface of the vehicle, and define the third detection area of the camera as a region extending 4 meters to less than 15 meters from the outer surface of the vehicle.

According to the present disclosure, a vehicle may comprise at least one sensor configured to detect a target object present within a preset threshold distance from the vehicle during autonomous driving, a processor, and a memory storing at least one instruction that, when executed by the processor, may cause the vehicle to obtain radar feature information using a radar signal input from a radar sensor of the at least one sensor, determine radar bird's-eye-view feature information based on the radar feature information, obtain ultrasonic feature information using an ultrasonic signal input from an ultrasonic sensor of the at least one sensor, determine ultrasonic bird's-eye-view feature information based on the ultrasonic feature information, obtain image feature information using image data captured from an image sensor of the at least one sensor, update the image feature information based on first depth information associated with a first detection area of the radar sensor and second depth information associated with a second detection area of the ultrasonic sensor, perform view transformation on the updated image feature information, determine image bird's-eye-view feature information based on the view-transformed image feature information, output a signal indicating detected objects based on fusion of the radar bird's-eye-view feature information, the ultrasonic bird's-eye-view feature information, and the image bird's-eye-view feature information, and control an operation of the vehicle based on the signal.

The at least one instruction may further cause the vehicle to determine a radar weight map by assigning a first weight to regions within the first detection area at a magnitude higher than those assigned outside the first detection area, determine an ultrasonic weight map by assigning a second weight to regions within the second detection area at a magnitude higher than those assigned outside the second detection area, and determine an image weight map by assigning a uniform weight to regions within a third detection area of the image sensor, the uniform weight having a value between the first and second weights. The at least one instruction may further cause the vehicle to generate a radar weight map by assigning a weight to the first detection area of the radar sensor, adjust weight values of portions of the radar bird's-eye-view feature information associated with the first detection area based on the radar weight map, determine a radar bird's-eye-view feature information map based on the adjusted values, generate an image weight map by assigning a weight to a third detection area of the image sensor, adjust weight values of portions of the image bird's-eye-view feature information associated with the third detection area based on the image weight map, determine an image bird's-eye-view feature information map based on the adjusted values, generate an ultrasonic weight map by assigning a weight to the second detection area of the ultrasonic sensor, adjust weight values of portions of the ultrasonic bird's-eye-view feature information associated with the second detection area based on the ultrasonic weight map, determine an ultrasonic bird's-eye-view feature information map based on the adjusted values, and determine a fused bird's-eye-view feature information map based on fusion of the radar, image, and ultrasonic bird's-eye-view feature information maps.

The at least one instruction may further cause the vehicle to determine a radar weight map by assigning a maximum weight value to pixels within the first detection area and a minimum weight value to pixels outside the first detection area, and to determine an ultrasonic weight map by assigning a maximum weight value to pixels within the second detection area and a minimum weight value to pixels outside the second detection area. The at least one instruction may further cause the vehicle to determine an image weight map by assigning a weight value smaller than a maximum weight value and greater than a minimum weight value to pixels included in the third detection area of the image sensor.

The at least one instruction may further cause the vehicle to define the first detection area of the radar sensor as a region located farther from an outer surface of the vehicle than the second detection area of the ultrasonic sensor and to define the third detection area of the image sensor as a region overlapping at least partially with the first detection area.

According to the present disclosure, a vehicle may comprise a plurality of sensors configured to capture sensor data associated with a surrounding environment of the vehicle, including a radar sensor configured to detect objects within a first detection area, an ultrasonic sensor configured to detect objects within a second detection area, and a camera configured to capture image data within a third detection area; a driving control circuit configured to control autonomous driving of the vehicle; and a processor circuit configured to obtain radar feature information based on a radar signal of the radar sensor, obtain ultrasonic feature information based on an ultrasonic signal of the ultrasonic sensor, obtain camera-image feature information based on image data of the camera, generate radar, ultrasonic, and camera-image bird's-eye-view feature information respectively based on the obtained feature information, determine radar, ultrasonic, and camera-image weight maps corresponding to the respective detection areas, generate weighted bird's-eye-view feature information by applying the respective weight maps to the respective bird's-eye-view feature information, output a signal indicating detected objects based on the weighted bird's-eye-view feature information, and control autonomous driving of the vehicle via the driving control circuit based on the signal.

The processor circuit may further cause the vehicle to adjust depth information of the camera-image bird's-eye-view feature information by using depth information derived from the radar feature information and the ultrasonic feature information prior to generating the weighted bird's-eye-view feature information.

The processor circuit may further cause the vehicle to define the first detection area of the radar sensor as a region located farther from an outer surface of the vehicle than the second detection area of the ultrasonic sensor and to define the third detection area of the camera as a region overlapping at least partially with both the first and second detection areas.

The processor circuit may further cause the vehicle to construct the radar weight map such that regions farther from the vehicle are assigned greater weights than regions closer to the vehicle and to construct the ultrasonic weight map such that regions closer to the vehicle are assigned greater weights than regions farther from the vehicle. The processor circuit may further define the first detection area of the radar sensor as a predetermined first distance range extending from an outer surface of the vehicle, define the second detection area of the ultrasonic sensor as a predetermined second distance range extending from the outer surface of the vehicle and shorter than the first distance range, and define the third detection area of the camera as a predetermined third distance range extending from the outer surface of the vehicle and overlapping at least in part with the first distance range.

The processor circuit may further cause the vehicle to generate a fused bird's-eye-view feature information map based on fusion of the radar bird's-eye-view feature information, the ultrasonic bird's-eye-view feature information, and the camera-image bird's-eye-view feature information, wherein the fused map represents the surrounding environment of the vehicle. The processor circuit may further cause the vehicle to detect at least one object within the second detection area based on fusion of the radar, ultrasonic, and camera-image bird's-eye-view feature information and to output a control signal for short-range braking or parking assistance. The processor circuit may further cause the vehicle to update a planned driving trajectory based on detection of a nearby vehicle within the first detection area.

The advantages and effects attainable through the present disclosure are not limited to those expressly recited above. Additional advantages and effects, which have not been explicitly mentioned, will be apparent to, and readily appreciated by, those of ordinary skill in the art to which the present disclosure pertains from the following description.

### BRIEF DESCRIPTION OF THE DRAWINGS

The above and other objects, features and advantages of the present disclosure will become more apparent to those of ordinary skill in the art by describing examples thereof in detail with reference to the accompanying drawings, in which:

FIG. 1 shows an example that a vehicle transmits and receives data by communicating with another device.

FIG. 2 shows exemplary modules constituting a vehicle.

FIG. 3 shows an example of a detailed configuration of a processor and a memory for autonomous driving control in an autonomous driving device.

FIG. 4 shows an example of components that process distance-adaptive sensor fusion.

FIG. 5 shows an example of an ROI that is set for each sensor included in a vehicle.

FIG. 6A shows an example of feature information and BEV feature information processed by the view transformation unit of FIG. 4.

FIG. 6B shows an example of weight maps and BEV feature information maps processed by the sensor fusion unit of FIG. 4.

FIG. 7 shows an example of an operation of the distance-adaptive sensor fusion method.

FIG. 8 shows an example computing system.

### DETAILED DESCRIPTION

The advantages and features of the examples and the methods of accomplishing the examples will be clearly understood from the following description taken in conjunction with the accompanying drawings. However, examples are not limited to those examples described, as examples may be implemented in various forms. It should be noted that the present examples are provided to make a full disclosure and to allow those skilled in the art to know the full range of the examples. Therefore, the examples are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of modern technologies, and the like. In addition, in certain cases, there are terms arbitrarily selected by the applicant, and in this case, the meaning of the terms will be described in detail in the description of the corresponding disclosure. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

For purposes of this application and the claims, using the exemplary phrase “at least one of: A; B; or C” or “at least one of A, B, or C,” the phrase means at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all combinations of the listed items. For example, “at least one of A or B” may refer to (1) at least one A; (2) at least one B; or (3) at least one A and at least one B.

The term “module,” “unit,” or “portion” used in the specification means a software and/or hardware component, and the “module,” “unit,” or “portion” performs certain operations/functions/roles. However, the “module,” “unit,” or “portion” is not construed as being limited to software or hardware. The “module,” “unit,” or “portion” may be configured to be in an addressable storage medium or to execute one or more processors. Therefore, as an example, the “module,” “unit,” or “portion” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules,” “units,” or “portions” may be combined into a smaller number of components, “modules,” “units,” or “portions” or further divided into additional components, “modules,” “units,” or “portions”.

In the present disclosure, the “module,” “unit,” or “portion” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium to be executed on a computer. The medium may either continuously store a computer-executable program or temporarily store the program for execution or download. Furthermore, the medium may be a variety of recording or storage means in the form of a single hardware device or multiple combined hardware devices and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control settings (e.g., an autonomous driving classification or level selection). Based on one or more features (e.g., feature of fusion-weighted mapping integrating multiple sensor data by detection ranges) described herein, an operation of the vehicle may be adaptively controlled. For instance, when radar-weighted mapping indicates high-confidence detection in a long-range zone (e.g., 40-100 m) while ultrasonic-weighted data reveal a close obstacle (e.g., within 3 m), the processor may reduce acceleration and activate short-range braking to maintain a safe distance. Similarly, when camera-weighted data confirm clear lateral regions, the vehicle may automatically perform a lane-centering or avoidance maneuver. Thus, autonomous driving control dynamically adjusts braking, steering, and acceleration timing according to the reliability of distance-based sensor fusion. One or more auxiliary devices (e.g., engine brake, exhaust brake, hydraulic retarder, electric retarder, or regenerative brake) may also be controlled, for example, based on one or more features (e.g., feature of fusion-weighted mapping integrating multiple sensor data by detection ranges) described herein. For instance, when radar-weighted mapping indicates a long-range obstacle (e.g., 40-80 m ahead) but the camera and ultrasonic data show clear conditions nearby, the processor may pre-activate an engine brake or retarder to gradually decelerate while maintaining stability. Conversely, when ultrasonic-weighted mapping detects a close obstacle (e.g., within 2 m), the processor may trigger the regenerative brake or hydraulic retarder for immediate low-speed stopping. Thus, auxiliary braking devices may be adaptively coordinated according to distance-based sensor fusion to enhance predictive deceleration and energy recovery efficiency. One or more communication devices (e.g., a modem, a network adapter, a radio transceiver, or an antenna) may also be controlled, for example, based on one or more features (e.g., feature of fusion-weighted mapping integrating multiple sensor data by detection ranges) described herein. For instance, when the fusion-weighted mapping indicates high-confidence radar detection in a long-range area (e.g., 4-100 m), the processor may trigger vehicle-to-vehicle (V2V) communication to broadcast predicted trajectories of surrounding vehicles for cooperative maneuvering. Conversely, when short-range ultrasonic-weighted data (e.g., within 0.2-4 m) show potential close obstacles, the processor may prioritize low-latency vehicle-to-infrastructure (V2I) communication with nearby roadside units to request environmental updates or emergency control coordination. Thus, communication resources and protocol selection may dynamically adapt based on fusion-weighted detection reliability to enhance awareness and connectivity efficiency. Minimum risk maneuver (MRM) operation(s) may also be controlled, for example, based on one or more features (e.g., feature of fusion-weighted mapping integrating multiple sensor data by detection ranges) described herein. For instance, the processor may determine a minimum-risk trajectory based on a fused BEV feature information map that reflects confidence levels of radar, ultrasonic, and camera data according to distance. When radar-weighted mapping indicates a clear long-range path (e.g., 4-100 m) but ultrasonic-weighted regions show nearby obstacles (e.g., within 0.2-4 m), the processor may initiate an MRM by decelerating and steering toward the radar-cleared zone. Conversely, when all sensors show low-confidence detection or close-range obstruction, the processor may guide the vehicle to perform a controlled stop within a short safe zone. Thus, the MRM control dynamically adapts to distance-based sensor fusion reliability to ensure collision avoidance and stability during autonomous fallback.

Biased driving operation(s) may also be controlled, for example, based on one or more features (e.g., feature of fusion-weighted mapping integrating multiple sensor data by detection ranges) described herein. For instance, the processor may determine a lateral bias of the vehicle within a lane according to confidence levels in a fused BEV feature information map constructed from radar, ultrasonic, and camera data. When the fusion-weighted mapping indicates higher reliability in radar-based long-range detection (e.g., 4-100 m) on one side of the vehicle, the driving control apparatus may bias the driving path toward that side to enhance obstacle prediction and stability during high-speed cruising. Conversely, when stronger ultrasonic-weighted responses are detected at short range (e.g., within 0.2-4 m), the vehicle may bias the trajectory away from nearby obstacles or curbs to maintain a safe clearance during low-speed maneuvers or parking. Thus, the biased driving control dynamically adapts according to distance-dependent fusion weighting to improve lateral safety and environmental responsiveness.

One or more sensors (e.g., IMU sensors, camera, LIDAR, RADAR, ultrasonic sensor, parking sensor, or blind spot monitoring sensor) may also be controlled, for example, based on one or more features (e.g., feature of fusion-weighted mapping integrating multiple sensor data by detection ranges) described herein. For instance, the processor may adjust activation timing, sensing frequency, or field of view of each sensor according to fusion-weighted reliability derived from distance-based weight maps. When the fused BEV feature information indicates a low-confidence region in short-range detection (e.g., within 0.2-4 m), the processor may increase ultrasonic sampling or activate additional cameras for redundancy. Conversely, when radar-weighted mapping in a long-range region (e.g., 4-100 m) shows stable detection, the processor may reduce ultrasonic sensor operation to conserve power. Thus, the sensors may be dynamically coordinated based on the fusion-weighted mapping to maintain perception accuracy and operational efficiency. An autonomous driving level and/or autonomous driving activation or deactivation may also be controlled based on one or more features (e.g., feature of fusion-weighted mapping integrating multiple sensor data by detection ranges) described herein. For example, the processor may refer to a fused BEV feature information map constructed by applying distance-based weight maps respectively to radar, ultrasonic, and camera data. When the fusion-weighted mapping indicates reliable long-range detection (e.g., 4-100 m) from the radar-weighted region, the processor may maintain or elevate the autonomous driving level for highway cruising. Conversely, when the fused map shows stronger confidence only within short-range ultrasonic-weighted areas (e.g., 0.2-4 m), the processor may lower the autonomous driving level or deactivate autonomous driving to support low-speed or parking maneuvers. Thus, the autonomous driving control dynamically adapts according to distance-dependent sensor fusion characteristics, improving safety and situational robustness.

According to the present disclosure, a distance-adaptive sensor fusion system may be provided to improve object detection and recognition in a vehicle. The system may use a camera, radar sensor, and ultrasonic sensor, each having different detection ranges and characteristics. Depth information obtained from the radar and ultrasonic sensors may be incorporated into image data from the camera to generate a bird's-eye-view (BEV) representation of objects in a surrounding environment of the vehicle. A distance-based weight map may then be applied so that radar data dominates at long range, ultrasonic data at short range, and camera data provides continuity across all ranges. By adaptively combining sensor data in such manner, the system may enhance depth accuracy and object recognition performance under various driving conditions, from highway travel to low-speed parking.

Hereinafter, the example of the present disclosure will be described in detail with reference to the accompanying drawings so that those of ordinary skill in the art may easily implement the present disclosure. In the drawings, portions not related to the description are omitted to clearly describe the present disclosure.

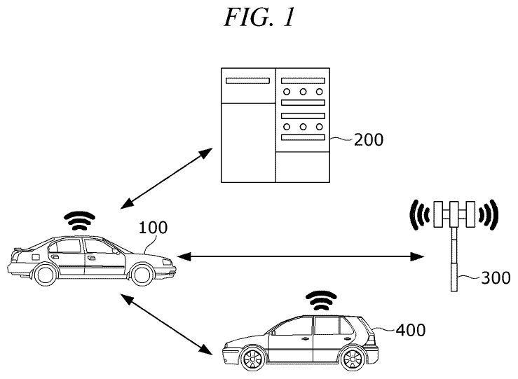

FIG. 1 shows an example that a vehicle transmits and receives data by communicating with another device.

Referring to FIG. 1, the vehicle 100 may be driven based on electric energy or fossil energy. In the case of electric energy, the vehicle 100 may adopt a pure battery-based vehicle driven solely by a high-voltage battery or a gas-based fuel cell as an energy source. The fuel cell may utilize various types of gases capable of generating electric energy, and the gas may be filled in the vehicle 100 in a liquefied state. For instance, the gas may be hydrogen, but various other gases may also be applicable (e.g., methane, ammonia, or natural gas, etc.). In the case of fossil energy, the vehicle 100 may be driven based on fuels such as gasoline, diesel, or liquefied gas, and it may be equipped with an internal combustion engine that drives an actuator 116 by burning the fuel. The engine may be included in an energy generator 110 in terms of providing rotational driving force to the wheel driver 118. As another example, the vehicle 100 may be a hybrid type vehicle selectively utilizing the energy of a fossil fuel-based internal combustion engine and an electric battery to drive the actuating unit 116 (e.g., a plug-in hybrid vehicle, mild hybrid vehicle, or range-extended electric vehicle, etc.).

The vehicle 100 may refer to a movable device. The vehicle 100 may be a ground vehicle, such as a typical passenger or commercial vehicle, or a purpose-built vehicle (PBV) for specific purposes (e.g., a delivery van, shuttle bus, or mobile medical unit, etc.). The vehicle 100 may be a four-wheeled vehicle, such as a passenger car, SUV, or small truck, or a vehicle with more than four wheels, such as a bus, large truck, container carrier, or heavy equipment (e.g., a crane, excavator, or dump truck, etc.). The vehicle 100 may also be a robot in the broad sense of a movable means, and the robot may move using wheels, tracks, or other mobility modules (e.g., omni-wheels, articulated legs, or hovering mechanisms, etc.).

The vehicle 100 may be controlled and driven autonomously, and autonomous driving may be implemented as semi-autonomous driving or fully autonomous driving. Fully autonomous driving may be provided as autonomous movement in which the processor 122 of the vehicle 100 fully controls the driving without user intervention, even in uncertain driving conditions (e.g., heavy rain, snow, or low-visibility night driving, etc.). Semi-autonomous driving may be provided as autonomous movement that requires driver intervention in specific driving situations. Semi-autonomous driving may be implemented to enable manual driving by transferring control to the user when the processor 122 deactivates autonomous driving upon occurrence of such situations. According to the autonomous driving levels defined by the Society of Automotive Engineers (SAE), semi-autonomous driving may correspond to levels 1 to 4, and fully autonomous driving may correspond to level 5.

Meanwhile, the vehicle 100 may perform communication with other devices 200, 300, or other vehicles 400. The other devices may include, for example, a server 200 supporting various control state management and driving of the vehicle 100, an Intelligent Transportation System (ITS) device 300 for receiving information from ITS, and various types of user devices (e.g., smartphones, wearable devices, or vehicle key fobs, etc.). The server 200 may be an external device operated by a vehicle manufacturer or prepared to provide autonomous driving services and may transmit or receive connected data necessary for autonomous driving to or from the vehicle 100. The server 200 may transmit various information and software modules used for the control of the vehicle 100 in response to requests and data transmitted from the vehicle 100 and user devices to support autonomous driving and various services of the vehicle 100 (e.g., real-time map updates, over-the-air (OTA) software upgrades, or fleet-management coordination, etc.).

The ITS device 300, for instance, may be a Road Side Unit (RSU). The ITS device 300 may exchange vehicle perception data, driving control and state data, environmental data around the vehicle, and map data with the vehicle 100 through Vehicle-to-Infrastructure (V2I) communication to assist the user's driving or support autonomous driving of the vehicle 100 (e.g., by providing road-hazard alerts, traffic-signal phase information, or weather-related warnings, etc.). The vehicle 100 may support manual or autonomous driving by exchanging the aforementioned data with other vehicles 400 through Vehicle-to-Vehicle (V2V) communication (e.g., for cooperative lane changing, convoy driving, or collision avoidance, etc.).

The vehicle 100 may perform communication with other vehicles or devices based on cellular communication, Wireless Access in Vehicular Environment (WAVE) communication, Dedicated Short Range Communication (DSRC), or other communication methods. For instance, the vehicle 100 may use communication networks such as LTE or 5G, WiFi networks, or WAVE networks for communication with the server 200, ITS device 300, and other vehicles 400 (e.g., real-time position sharing, map synchronization, or vehicle status reporting, etc.). In another example, DSRC used in the vehicle 100 may be utilized for inter-vehicle communication. The communication methods among the vehicle 100, the server 200, the ITS device 300, other vehicles 400, and user devices are not limited to the above-described examples (e.g., future 6G-based communication or satellite-aided vehicular links may also be used, etc.).

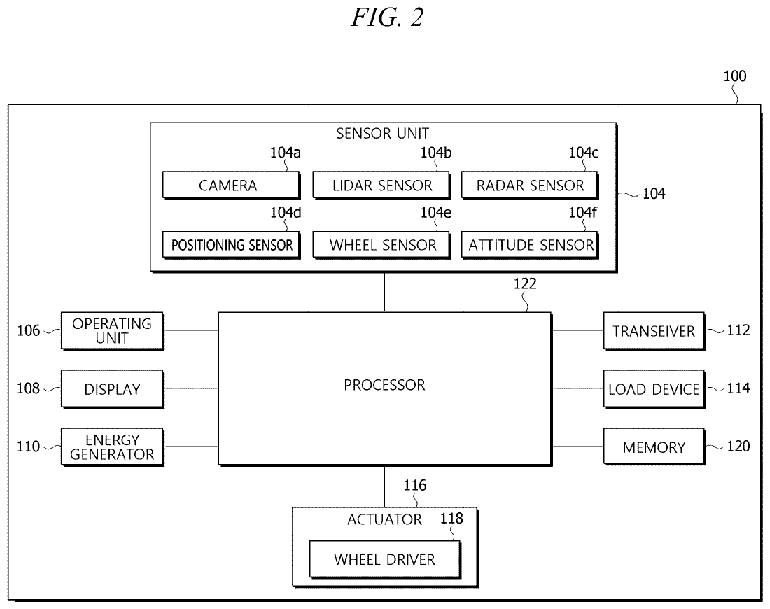

FIG. 2 shows exemplary modules constituting a vehicle according to one example of the present disclosure.

The vehicle 100 may include a sensor unit 104, an operating unit 106, a display 108, a load device 114, and a transceiver 112.

The sensor unit 104 may be equipped with various types of detectors to sense various states and situations occurring in the external environment, internal system, user operations, and passenger space of the vehicle 100. Specifically, the sensor unit 104 may include external-facing cameras 104a, LIDAR sensors 104b, radar sensors 104c, and the like to recognize dynamic and static objects existing outside the vehicle 100 (e.g., surrounding vehicles, pedestrians, road boundaries, traffic lights, or lane markings, etc.). The camera 104a may recognize external objects as images during the use of the vehicle 100, generate image data, and transmit the image data to the processor 122 (e.g., to detect lane lines, road signs, or obstacles, etc.). The LIDAR sensor 104b may generate point cloud data as recognized data of external objects to generate three-dimensional spatial information identifying the shape of at least the external objects and transmit the point cloud data to the processor 122 (e.g., for detecting curbs, guard rails, or parked vehicles, etc.). The radar sensor 104c may generate radar data by emitting radio waves of a specific frequency around the vehicle 100 and recognizing the external objects through the reflected radio waves to identify the presence, relative distance, speed, and direction of external objects (e.g., detecting approaching vehicles, cross-traffic, or stationary obstacles, etc.). Although the present disclosure illustrates including the LIDAR sensor 104b, it may not be included in other examples (e.g., low-cost vehicles relying solely on camera and radar sensing, etc.).

The sensor unit 104 may include a positioning sensor 104d (e.g., GPS, GNSS, or RTK module, etc.), wheel sensor 104e, and attitude sensor 104f to confirm its position, speed, and driving posture. The attitude sensor 104f may include a gyro sensor, angular velocity sensor, accelerometer, and the like (e.g., for detecting pitch, roll, or yaw of the vehicle body, etc.).

In the present disclosure, the sensor unit 104 includes sensors mainly referenced in the description of the examples but may further include sensors detecting various situations not listed herein (e.g., temperature sensors, rain sensors, driver-monitoring cameras, or cabin CO₂ sensors, etc.).

The operating unit 106 may be configured as a module for user control for driving. For instance, the operating unit 106 may include a steering wheel for manual driving, an automatic or manual transmission actuator, an accelerator pedal, a brake pedal, a gearbox, etc. The operating unit 106 may further include an interface for the use/deactivation of the autonomous driving mode requested by the user and the selection of detailed function to utilize the autonomous driving function (e.g., adaptive cruise, automated lane change, or valet parking, etc.). The operating unit 106 may be configured as a hard-type interface provided at a predetermined position inside the vehicle 100 or a soft-type interface touchable on the display 108 to receive various requests related to autonomous driving.

The display 108 may function as a user interface. The display 108 may display the operation state, control state, route/traffic information, remaining energy information, and contents requested by the driver of the vehicle 100 as controlled by the processor 122 (e.g., navigation route, camera feed, or driver alerts, etc.). The display 108 may also receive driver's requests instructing the processor 122 by being configured as a touch screen detecting driver input (e.g., touch gestures, virtual buttons, or voice-input confirmation, etc.).

The load device 114 may be mounted on the vehicle 100 and be a kind of electric device for non-driving use, excluding the driving power system such as the wheel driver 118. The load device 114 may be an auxiliary device supplied with power from the energy generator 110, such as an air conditioning system, lighting system, seat system, and various devices installed in the vehicle 100 (e.g., infotainment system, air purifier, or power window system, etc.).

The transceiver 112 may support mutual communication with the server 200, ITS device 300, and surrounding vehicles 300. The transceiver 112 may include modules handling cellular communication, WAVE, DSRC communication, etc. For instance, the transceiver 112 may transmit data generated or stored during driving to the server 200 and receive data and software modules transmitted from the server 200 (e.g., firmware updates, navigation corrections, or safety alerts, etc.). The transceiver 112 may also support communication with electronic devices carried by passengers inside the vehicle 100. In the present disclosure, the vehicle 100 may transmit and receive data utilized in the methods according to the present disclosure through the transceiver 116.

The vehicle 100 may also include an energy generator 114 and an actuating unit 116.

The energy generator 110 may generate and supply power and electricity used in the driving power system, such as the actuating unit 118, and the non-driving power system. The non-driving power system may include, for example, the sensor unit 104, operating unit 106, display 108, load device 114, transceiver 112, and the like, and may include various components implementing sensing, interface, communication, and convenience functions, excluding components directly involved in driving operations (e.g., climate control, cabin lighting, or seat adjustment systems, etc.). When the vehicle 100 is driven based on electric energy, the energy generator 110 may be configured as an electric battery charged from an external source or a combination of an electric battery and a fuel cell charging the battery (e.g., lithium-ion battery combined with a hydrogen fuel cell, etc.). In the case of a combination of an electric battery and a fuel cell, the energy generator 110 may include a tank storing a material, such as liquefied hydrogen, used to generate power in the fuel cell. When the vehicle 100 is driven based on fossil energy, the energy generator 110 may be configured as an internal combustion engine (e.g., gasoline, diesel, or LPG engine, etc.). Additionally, when the vehicle 100 is of a hybrid type, the energy generator 110 may be provided as a combination of an internal combustion engine and an electric battery.

The actuator 116 may include at least one module implementing driving operations and may perform at least one of longitudinal control, such as acceleration and deceleration, and lateral control, such as steering, based on user requests from the operating unit 106 (e.g., accelerator pedal input, lane-keeping request, or adaptive braking, etc.). The actuator 116 may include mechanical components and electronic modules implementing driving operations in the wheel driver 118 to perform driving operations according to commands of the processor 122 for manual control or autonomous driving. When the vehicle 100 is operated based on electric energy, it may include an assembly for delivering the requested driving operations to the wheel driver 118 (e.g., inverter modules or motor controllers, etc.). When the vehicle 100 is operated based on fossil energy, the actuator 116 may include a transmission gear module delivering the power of the internal combustion engine.

The wheel driver 118 may include a driving force generating module generating driving force for multiple wheels or transferring driving force to the wheels, a braking module decelerating the driving of the wheels, and a steering module realizing lateral control of the wheels (e.g., by controlling torque vectoring or steer-by-wire systems, etc.). When the vehicle 100 is driven based on electric energy, the driving force generating module may be configured as a motor assembly generating driving force based on the power output from the electric battery (e.g., an induction motor or permanent magnet synchronous motor, etc.). The braking module of the electric-based vehicle 100 may further have a regenerative braking function (e.g., converting kinetic energy to battery charge during deceleration, etc.).

In addition, the vehicle 100 may include a memory 120 and a processor 122.

The memory 120 may store applications and various data for controlling the vehicle 100, and load applications or read and record data by a request of the processor 122 (e.g., store navigation maps, diagnostic logs, or AI model parameters, etc.). In the present disclosure, the memory 120 may store an application and at least one instruction for determining a traffic congestion situation for a driving area of the autonomous vehicle 100 and generating congestion control information based on the traffic congestion situation (e.g., vehicle density, travel speed, or average delay time, etc.). In addition, the memory 120 may generate final longitudinal control information based on various data including congestion control information and hold applications and instructions for controlling the vehicle 100 in the traffic congestion situation according to the information.

The longitudinal control may be control related to a speed, an acceleration, and a relative distance to a surrounding vehicle of the vehicle 100 (e.g., maintaining a set following distance, adjusting acceleration when approaching slower traffic, or reducing speed near intersections, etc.). As one example, the longitudinal control may be motion control in autonomous driving. As another example, the longitudinal control may be used in manual driving as well as autonomous driving. When there is a manual operation that is different from an operation appropriate for the surrounding situation, the processor 122 may intervene in manual driving with the longitudinal control that matches the surrounding situation, or may provide longitudinal control-related data to a manual driver (e.g., through haptic feedback, dashboard warnings, or adaptive braking assistance, etc.).

Accordingly, as one example, the longitudinal control information may include a speed and an acceleration applied to the vehicle 100. The speed and the acceleration may be generated as longitudinal data that applies to any one of a time range, a distance range, or a specific section along a route (e.g., acceleration over a 100 m merge section, deceleration within a 10-second stop phase, or constant-speed cruise along a highway segment, etc.). The longitudinal control information may be described as profiles of continuous velocity and acceleration over the range or section. As another example, in addition to the speed and the acceleration, the longitudinal control information may further include control factors applied to the vehicle 100, for example, control according to a relative required distance to surrounding vehicles (e.g., adjusting braking sensitivity, throttle delay, or following distance margin, etc.).

The memory 120 may manage road information, surrounding object information, and vehicle information to generate final longitudinal control information depending on the presence or absence of the traffic congestion situation.

The road information may include lane level route information, road restriction information, a road structure, a traffic sign information, and road event information related to the driving lane in which the vehicle 100 moves and surrounding lanes. In the present disclosure, the road on which the vehicle 100 moves may have a plurality of lanes and may specifically include a driving lane on which the vehicle 100 travels and surrounding lanes near the driving lane. The lane level route information may be obtained from lane images or map information acquired from, for example, the camera 104a (e.g., lane boundaries, arrows, or surface markings, etc.). The map information is, for example, a lane-level precision map, and may be obtained from an external device such as the server 200 and managed in the memory 120. The lane level route information may include a trajectory (or route) of each lane, its width, parameters applied to functions related to each lane, and the like (e.g., curvature parameters, slope data, or merge-point identifiers, etc.). The road restriction information may be a speed limit required on the road on which the vehicle 100 is traveling and a vehicle behavior required to comply with regulations related to the corresponding road (e.g., no-entry zones, school zones, or yield requirements, etc.). The traffic sign information may be information related to traffic control and guidance displayed on a road surface and signs installed on the road. The traffic sign information may include, for example, crosswalks, stop lines, U-turns, left turns, speed limits, milestones, and the like (e.g., warning triangles, lane-change restrictions, or temporary construction detours, etc.).

The road structure may be related to a road shape. The road structure may include information representing, for example, the number of lanes, a road geometry such as a straight or curved line, a road merging section, a road branch section, a road gradient, a tunnel section, road three-dimensionality (e.g., a ground road, an elevated road, or an underpass, etc.), and the like. The road event information may be information related to an event on the road. The road event information may include, for example, a construction zone, road event information, and a slow-speed section due to severe weather (e.g., snow accumulation, heavy rainfall, or black-ice detection, etc.).

The surrounding object information may include data related to the behavior of dynamic objects around the vehicle 100. The surrounding object information is behavior data derived by analyzing dynamic objects obtained from at least one of the sensor unit 104, the intelligence transportation system (ITS) device 300, and other vehicles 100 by the processor 122, and the behavior data may be managed in the memory 120. Dynamic objects may be, for example, surrounding vehicles, pedestrians, or other types of mobility, and other types of mobility may be personal mobility such as bicycles or electric scooters (e.g., e-bikes, kick scooters, or wheelchairs, etc.). The behavior of the dynamic object may include information related to the position, speed, motion, or the like, of the dynamic object. The speed may include, for example, the speed of each surrounding vehicle and the average speed of surrounding vehicles in a predetermined area (e.g., an average convoy speed in a traffic cluster, etc.). The motion may be defined based on a movement pattern of the dynamic object. Taking a vehicle as an example, the motion may be referred to as a driving motion of the vehicle, and the driving motion may be divided into lane keeping driving and biased driving. The lane keeping driving may be a motion in which surrounding vehicles travel along center areas of their own lanes without deviating from the lanes, thereby causing no interference with the driving of the host vehicle traveling in the adjacent lane. The bias driving may be a motion in which a surrounding vehicle does not deviate from its own lane, but travels eccentrically from the center area and approaches the driving lane used by the host vehicle or some of surrounding vehicles deviate from their own lanes and enter the lane of the host vehicle, thereby causing interference with the driving of the host vehicle (e.g., due to sudden lane changes, merging maneuvers, or obstacle avoidance, etc.).

The vehicle information may refer to information related to the vehicle according to an example of the present disclosure. The vehicle information may include data related to a longitudinal state of the vehicle 100, a sensing detection range of the surrounding environment of the sensor unit 104 mounted on the vehicle 100, and autonomous driving control. The longitudinal state may include a driving lane, a position, a speed, an acceleration, and a distance to a surrounding vehicle of the vehicle 100, and may be acquired by the camera 104a, the positioning sensor 104d, the wheel sensor 104e, the attitude sensor 104f, the radar sensor 104c, and the like, and managed in the memory 120 (e.g., as a time-stamped vehicle-state log, etc.). The sensing detection range may be a distance and an area detected by the detection performance of the sensor unit 104 that varies depending on the road shape, weather, or the like (e.g., shorter range in fog, longer range on straight roads, etc.). The road shape and weather may be confirmed by road information, surrounding situations detected by the sensor unit 104, and external information provided by the server 200 or the like. Specifically, the detection range of the camera 104a, the lidar sensor 104b, and the radar sensor 104c varies depending on a gradient of a front road and the weather, and the variable detection range may be managed in the memory 120 as the sensing detection range. As another example, the detection range according to the gradient and weather may be stored in the memory 120 in a pre-tabulated form (e.g., lookup tables indexed by slope angle and visibility condition, etc.).

The data related to autonomous driving control may include a control plan according to various driving situations of the vehicle 100. Here, the driving situation may be, for example, evasive driving, following a preceding vehicle, changing lanes, driving at an intersection, or the like (e.g., merging onto a highway, overtaking, or exiting a ramp, etc.). In the present disclosure, the data may be described mainly in terms of a control plan (or an action plan) related to control transfer from autonomous driving to manual driving among various driving situations but is not limited thereto. The action plan may be a plan to reduce instability due to the control transfer, that is, the risk of autonomous driving. When a driving situation that the processor 122 cannot handle occurs, the action plan related to the control transfer may include, for example, a control to notify a user of the transfer in advance and move the vehicle 100 to a safe area on the road at a specific speed and stop the vehicle 100 when the user does not operate the vehicle 100 for a specified period of time after the notification (e.g., using an emergency pull-over maneuver or controlled deceleration sequence, etc.). The transfer-related action plan is not limited to the above-described examples and may be established using various methods and speeds (e.g., different deceleration profiles, side-lane stops, or adaptive user alerts, etc.).

The map information stored in the memory 120 may be used to generate a driving route set in the vehicle 100 by the request of the user or the processor 122. In addition, the map information is utilized for autonomous driving and may include a low-precision map or include a high-precision map together with the map (e.g., global navigation map combined with centimeter-level lane data, etc.). The map information may be provided to have various information and data included in driving environment information (e.g., topography, road slope, or signal-location metadata, etc.).

The processor 122 may perform overall control of the vehicle 100. The processor 122 may be configured to execute applications and instructions stored in the memory 120 (e.g., perception algorithms, trajectory planners, or control loops, etc.).

Hereinafter, a detailed configuration of a processor and a memory for autonomous driving control of a vehicle will be described.

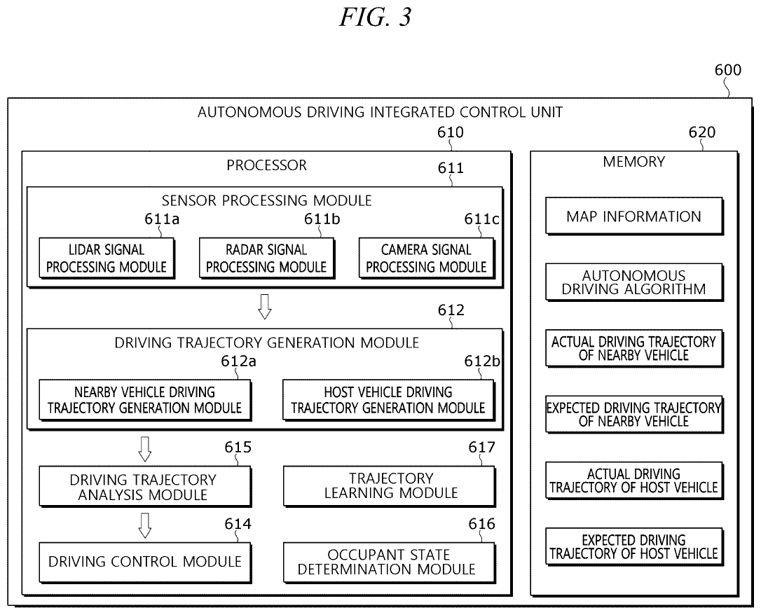

FIG. 3 shows an example of a detailed configuration of a processor and a memory for autonomous driving control in an autonomous driving device according to an example of the present disclosure.

Referring to FIG. 3, a memory 620 may store basic information necessary for autonomous driving control of a vehicle or information generated when autonomous driving of the vehicle is controlled by a processor 610, and the processor 610 may access (read) the information stored in the memory 620 to control the autonomous driving of the vehicle. The memory 620 may be implemented as a computer-readable recording medium and may operate so that the processor 610 may access the memory. Specifically, the memory 620 may be implemented as a hard drive, a magnetic tape, a memory card, a read-only memory (ROM), a random access memory (RAM), or an optical data storage device such as a digital video disc (DVD) or an optical disc (e.g., Blu-ray, CD-ROM, or DVD-ROM, etc.).

The memory 620 may store map information required for autonomous driving control by the processor 610. The map information stored in the memory 620 may be a navigation map (digital topographic map) that provides information in road units, but may be preferably implemented as a precision road map that provides road information in lane units in order to improve the precision of autonomous driving control, that is, three-dimensional (3D) high-precision electronic map data. Accordingly, the map information stored in the memory 620 may provide dynamic and static information necessary for the autonomous driving control of the vehicle, such as lanes, lane centerlines, regulatory lines, road boundaries, road centerlines, traffic signs, road surface signs, road shapes and heights, and lane widths (e.g., lane curvature, slope grade, or intersection geometry, etc.).

Further, the memory 620 may store an autonomous driving algorithm for the autonomous driving control of the vehicle. The autonomous driving algorithm is an algorithm (e.g., including recognition, determination, or control logic, etc.) for recognizing surroundings of the autonomous vehicle, determining a state thereof, and controlling the driving of the vehicle based on a result of the determination, and the processor 610 may execute the autonomous driving algorithm stored in the memory 620 to perform active autonomous driving control in the surrounding environment of the vehicle (e.g., lane keeping, adaptive cruise, or automated lane change, etc.).

The processor 610 may control autonomous driving of the vehicle based on driving information and traveling information input from the interface provided through the display 108 described above, information on nearby objects detected through the sensor unit 104, the map information and the autonomous driving algorithm stored in the memory 620. The processor 610 may be implemented as an embedded processor such as a complex instruction set computer (CISC) or a reduced instruction set computer (RISC), or a dedicated semiconductor circuit such as an application specific integrated circuit (ASIC) (e.g., an SoC with GPU/TPU accelerators, an FPGA, or a microcontroller cluster, etc.).

In the present example, the processor 610 may analyze respective driving trajectories of the host vehicle and a nearby vehicle to control autonomous driving of the host vehicle, and to this end, the processor 610 may include a sensor processing module 611, a driving trajectory generation module 612, a driving trajectory analysis module 613, a driving control module 614, a trajectory learning module 615, and an occupant state determination module 616, as illustrated in FIG. 3. Although FIG. 3 illustrates respective modules as independent blocks according to their functions, the modules may be integrated into one module to perform respective functions in an integrated manner (e.g., combined into an autonomous-driving control unit, etc.).

The sensor processing module 611 may determine driving information of the nearby vehicle (that is, which includes a position of the nearby vehicle and may further include a speed and moving direction of the nearby vehicle together with the position) based on a result of detecting a vehicle near the host vehicle through the sensor unit 104. That is, the sensor processing module 611 may determine the position of the nearby vehicle based on a signal received through a lidar sensor 104b, may determine the position of the nearby vehicle based on a signal received through the radar sensor 104c, or may determine the position of the nearby vehicle based on an image captured through the camera 104a (e.g., mono-camera triangulation, stereo disparity, or visual odometry landmarks, etc.). A method of determining the position of the nearby vehicle by utilizing the lidar sensor 104b, the radar sensor 104c, and the camera 104a is a specific example, and an implementation scheme therefor is not limited. Further, the sensor processing module 611 may determine attribute information such as a size and type of the nearby vehicle as well as the position, speed, and moving direction of the nearby vehicle, and an algorithm for determining information such as the position, speed, moving direction, size, and type of the nearby vehicle as described above may be defined in advance (e.g., classifier for car/truck/bus, pedestrian detection, or cyclist detection, etc.).

The driving trajectory generation module 612 may generate the actual driving trajectory and expected driving trajectory of the nearby vehicle and the actual driving trajectory of the host vehicle, and to this end, the driving trajectory generation module 612 may include a nearby vehicle driving trajectory generation module 612a and a host vehicle driving trajectory generation module 612b, as illustrated in FIG. 3.

First, the nearby vehicle driving trajectory generation module 612a may generate the actual driving trajectory of the nearby vehicle.

Specifically, the nearby vehicle driving trajectory generation module 612a may generate the actual driving trajectory of the nearby vehicle based on the driving information of the nearby vehicle detected by the sensor unit 104 (that is, the position of the nearby vehicle determined by the sensor processing module 611). In this case, in order to generate the actual driving trajectory of the nearby vehicle, the nearby vehicle driving trajectory generation module 612a may refer to the map information stored in the memory 620, and may generate the actual driving trajectory of the nearby vehicle by cross-referencing the position of the nearby vehicle detected by the sensor unit 104 and an arbitrary position in the map information stored in the memory 620. For example, when the nearby vehicle is detected at a specific point by the sensor unit 104, the nearby vehicle driving trajectory generation module 612a may specify the position of the currently detected nearby vehicle in the map information by cross-referencing the position of the detected nearby vehicle and the arbitrary position in the map information stored in the memory 620, and may generate the actual driving trajectory of the nearby vehicle by continuously monitoring the position of the nearby vehicle as described above. That is, the nearby vehicle driving trajectory generation module 612a may generate the actual driving trajectory of the nearby vehicle by mapping the position of the nearby vehicle detected by the sensor unit 104 to a corresponding position in the map information stored in the memory 620 based on the cross-reference and accumulating the position (e.g., using Kalman filtering, spline fitting, or pose-graph accumulation, etc.).

Meanwhile, the actual driving trajectory of the nearby vehicle may be compared with the expected driving trajectory of the nearby vehicle to be described below and utilized to determine whether the map information stored in the memory 620 is inaccurate. In this case, when an actual driving trajectory of a specific nearby vehicle is compared with an expected driving trajectory, a problem that the map information is incorrectly determined to be inaccurate even though the map information is accurate may occur. For example, when an actual driving trajectory and an expected driving trajectory of a number of nearby vehicles match, but an actual driving trajectory and an expected driving trajectory of any specific nearby vehicle do not match, comparing only the actual driving trajectory of the specific nearby vehicle with the expected driving trajectory may lead to an incorrect determination that the map information is inaccurate even though the map information is accurate. Therefore, it is necessary to determine whether actual driving trajectories of a plurality of nearby vehicles tend to deviate from expected driving trajectories, and to this end, the nearby vehicle driving trajectory generation module 612a may generate respective actual driving trajectories of the plurality of nearby vehicles (e.g., using aggregated multi-vehicle traces over time, etc.). Further, considering that a driver of the nearby vehicle tends to slightly move a steering wheel left and right during a driving process for driving on a straight path, the actual driving trajectory of the nearby vehicle may be generated in a curved form rather than a straight form, and in order to calculate an error between the actual driving trajectory and an expected driving trajectory to be described later, the nearby vehicle driving trajectory generation module 612a may apply a predetermined smoothing scheme to a raw actual driving trajectory generated in a curved form to generate the actual driving trajectory in a straight shape. Any scheme such as interpolation for each position of the nearby vehicle may be employed as the smoothing scheme (e.g., moving-average or cubic spline, etc.).

Further, the nearby vehicle driving trajectory generation module 612a may generate the expected driving trajectory of the nearby vehicle based on the map information stored in the memory 620.

As described above, the map information stored in the memory 620 may be three-dimensional high-precision electronic map data, and thus the map information may provide dynamic and static information necessary for autonomous driving control of the vehicle, such as lanes, lane centerlines, regulatory lines, road boundaries, road centerlines, traffic signs, road surface signs, road shapes and heights, and lane widths. Considering that a vehicle generally drives at a center of a lane, it may be expected that a nearby vehicle near the host vehicle will also travel at the center of the lane, and therefore, the nearby vehicle driving trajectory generation module 612a may generate the expected driving trajectory of the nearby vehicle as a lane centerline reflected in the map information (e.g., using lane polylines, clothoid parameters, or centerline splines, etc.).

The host vehicle driving trajectory generation module 612b may generate the actual driving trajectory along which the host vehicle has driven so far, based on the driving information of the host vehicle acquired through the interface provided through the display 108.

Specifically, the host vehicle driving trajectory generation module 612b may generate the actual driving trajectory of the host vehicle by cross-referencing the position of the host vehicle acquired through the interface provided through the display 108 (that is, the position information of the host vehicle acquired through a GPS receiver 260) and an arbitrary position in the map information stored in the memory 620. For example, the current position of the host vehicle may be specified in the map information by cross-referencing the position of the host vehicle acquired through the interface provided through the display 108 and the arbitrary position in the map information stored in the memory 620, and the actual driving trajectory of the host vehicle may be generated by continuously monitoring the position of the host vehicle as described above. That is, the host vehicle driving trajectory generation module 612b may generate the actual driving trajectory of the host vehicle by mapping the position of the host vehicle acquired through the interface provided through the display 108 to the corresponding position in the map information stored in the memory 620 based on the cross-reference and accumulating the position (e.g., fusing GNSS with wheel odometry or IMU data, etc.).

Further, the host vehicle driving trajectory generation module 612b may generate the expected driving trajectory along which the host vehicle should drive to the destination based on the map information stored in the memory.

That is, the host vehicle driving trajectory generation module 612b may generate the expected driving trajectory to the destination by using the current position of the host vehicle acquired through the interface (that is, current position information of the host vehicle acquired through the GPS receiver 260) and the map information stored in the memory, and the expected driving trajectory of the host vehicle may be generated as a lane center line reflected in the map information stored in the memory 620, like the expected driving trajectories of the nearby vehicle (e.g., using a routing path snapped to lane centerlines, etc.).

The driving trajectories generated by the nearby vehicle driving trajectory generation module 612a and the host vehicle driving trajectory generation module 612b may be stored in the memory 620 and may be utilized for various purposes when the processor 610 controls autonomous driving of the host vehicle (e.g., collision prediction, path replanning, or localization refinement, etc.).

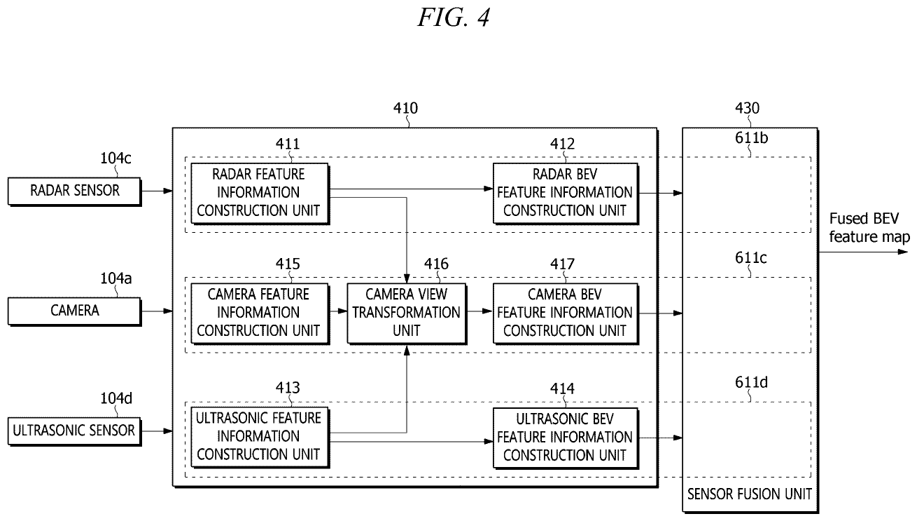

Further, an example of the present disclosure is characterized in that the nearby vehicle driving trajectory generation module 612a tracks a state trajectory of a target object near the host vehicle estimated from a position measurement value obtained by detecting the target object, and a detailed operation of tracking the state trajectory of the target object according to the example of the present disclosure will be described in detail with reference to FIGS. 4 to 7 below (e.g., Bayesian filtering, multiple-hypothesis tracking, or data association, etc.).

The driving trajectory analysis module 613 may diagnose a current reliability of the autonomous driving control for the host vehicle by analyzing respective driving trajectories (that is, the actual driving trajectory and expected driving trajectory of the nearby vehicle, and the actual driving trajectory of the host vehicle) generated by the driving trajectory generation module 612 and stored in the memory 620. The diagnosis of the reliability of the autonomous driving control may be performed by analyzing a trajectory error between the actual driving trajectory and the expected driving trajectory of the nearby vehicle (e.g., mean lateral offset, RMS deviation, or confidence interval width, etc.).

The driving control module 614 may perform a function of controlling autonomous driving of the host vehicle, and specifically, the driving control module 614 may comprehensively use driving information and traveling information input from the interface provided through the display 108 described above, information on nearby objects detected through the sensor unit 104, and the map information stored in the memory 620 to process the autonomous driving algorithm, and transfer control information through the interface provided through the display 108 to cause a low-level control system to control autonomous driving of the host vehicle. Further, when the driving control module 614 controls the autonomous driving as described above in an integrated manner, the driving control module 614 controls the autonomous driving in consideration of the driving trajectories of the host vehicle and the nearby vehicle analyzed by the sensor processing module 611, the driving trajectory generation module 612, and the driving trajectory analysis module 613 described above, thereby improving the precision and stability of the autonomous driving control (e.g., smoother lane keeping, fewer abrupt corrections, or reduced tracking error, etc.).

The trajectory learning module 615 may perform learning or correction on the actual driving trajectory of the host vehicle generated by the host vehicle driving trajectory generation module 612b. For example, when the trajectory error between the actual driving trajectory and the expected driving trajectory of the nearby vehicle is equal to or greater than a preset threshold value, it may be determined that the map information stored in the memory 620 is inaccurate and the actual driving trajectory of the host vehicle needs to be corrected, and accordingly, a lateral shift value for correcting the actual driving trajectory of the host vehicle may be determined so that the driving trajectory of the host vehicle can be corrected (e.g., applying an offset to lane centerline tracking, etc.).

The occupant state determination module 616 may determine a state and behavior of an occupant based on a state and bio signal of an occupant detected by an internal camera sensor 535 and a biosensor. The occupant state determined by the occupant state determination module 616 may be utilized when the autonomous driving of the host vehicle is performed or a warning is output to the occupant (e.g., drowsiness alert, distraction warning, or seat-belt reminder, etc.).

Hereinafter, a detailed operation of a distance-adaptive sensor fusion method according to an example of the present disclosure will be described in detail.

FIG. 4 shows an example of components that process distance-adaptive sensor fusion according to an example of the present disclosure.

Referring to FIG. 4, a distance-adaptive sensor fusion unit 400 may include a view transformation unit 410 and a sensor fusion unit 420.

The view transformation unit 410 may include a radar feature information construction unit 411 that constructs radar feature information by combining radar signals input from a radar sensor, and a radar bird's-eye-view (BEV) feature information construction unit 412 that constructs radar BEV feature information based on the radar feature information (e.g., range-Doppler maps, angle-of-arrival grids, or clustered detections, etc.). Further, the view transformation unit 410 may include an ultrasonic feature information construction unit 413 that constructs ultrasonic feature information by combining ultrasonic signals input from an ultrasonic sensor, and an ultrasonic BEV feature information construction unit 414 that constructs ultrasonic BEV feature information based on the ultrasonic feature information (e.g., echo amplitude maps, time-of-flight grids, or obstacle proximity bins, etc.).

The view transformation unit 410 may include a camera-image feature information construction unit 415 that constructs camera-image feature information by combining image signals input from a camera, and a camera-image BEV feature information construction unit 417 that constructs the camera-image BEV feature information based on the camera-image feature information (e.g., perspective-to-top-down projection, multi-camera stitching, or semantic segmentation features, etc.).

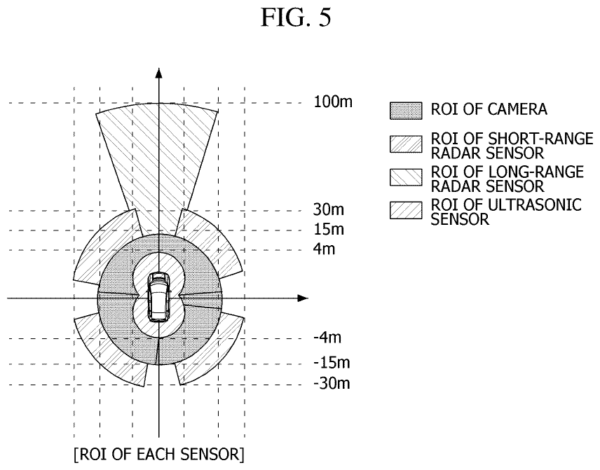

FIG. 5 shows an example of an ROI that is set for each sensor included in a vehicle according to an example of the present disclosure.

Referring to FIG. 5, since there is a difference in performance limitation and recognition distance between the sensors, the ROI set for each type of sensor is constructed differently. For example, the ROI of the ultrasonic sensor 104d may be set to be within 0.2 to 4 m, the ROI of the camera 104a may be set to range from 4 to 15 m, the ROI of a short-range radar sensor may be set to range from 15 to 30 m, and the ROI of the long-range radar sensor may be set to range from 15 to 100 m (e.g., the exact ranges may be calibrated per vehicle platform, sensor supplier, or mounting position, etc.).

Further, a time interval for detecting sensor data may be set differently for each type of sensor, and characteristics of detected data may be constructed differently (e.g., faster cycles for radar during highway driving, slower cycles for ultrasonic during parking, or adaptive camera frame rates in low light, etc.).

Considering the above, referring back to FIG. 4, the radar feature information construction unit 411, the ultrasonic feature information construction unit 413, the camera-image feature information construction unit 415, and the like may construct feature information according to the characteristics of respective sensors after preprocessing the input data. For example, the radar feature information construction unit 411 may preprocess data input from a radar sensor 104c through noise filtering, and then stack the filtered data along a time axis to sweep the filtered data and construct the radar feature information (e.g., CFAR detection, Doppler clutter removal, or temporal accumulation, etc.). The ultrasonic feature information construction unit 413 may preprocess data input from the ultrasonic sensor 104d by filtering a signal checked in a section in which a distance cannot be detected because the ROI is set to be relatively small, transform an input raw signal into a signal amplitude, and use the signal amplitude to construct the ultrasonic feature information (e.g., band-pass filtering, envelope detection, or threshold gating, etc.). The camera-image feature information construction unit 415 may encode and preprocess image data input from the camera 104a, and then construct camera-image feature information obtained by extracting key features in the image using a deep learning-based feature extraction network such as ResNet or CNN (e.g., edge/texture pyramids, object keypoints, or semantic masks, etc.).

Further, the radar feature information construction unit 411, the ultrasonic feature information construction unit 413, the camera-image feature information construction unit 415, and the like may perform synchronization on data preprocessed in the respective sensors based on timestamps (e.g., PTP/IEEE-1588 clocking, interpolation to nearest timestamp, or buffer alignment with tolerances, etc.).

Further, the view transformation unit 410 may generate the camera-image BEV feature information using the camera-image feature information generated by the camera-image feature information construction unit 415. When a Lift, Splat, Shoot (LSS) scheme is used to generate the camera-image BEV feature information using the camera-image feature information and image view transformation is performed, there are D depth stages for each pixel, a depth distribution α is estimated to determine which stage the depth of the pixel corresponds to, and the estimated depth distribution α is reflected in the feature map to generate BEV feature information. Thus, when the depth distribution α is estimated by using only the image and used to construct the camera-image BEV feature information, there is a problem that the reliability of the camera-image BEV feature information is degraded because the depth value has low accuracy (e.g., textureless regions, adverse weather, or motion blur, etc.).

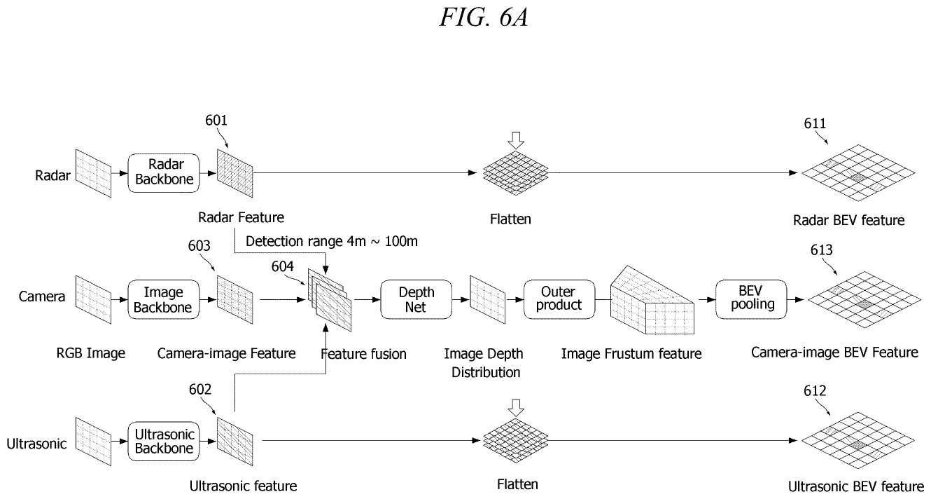

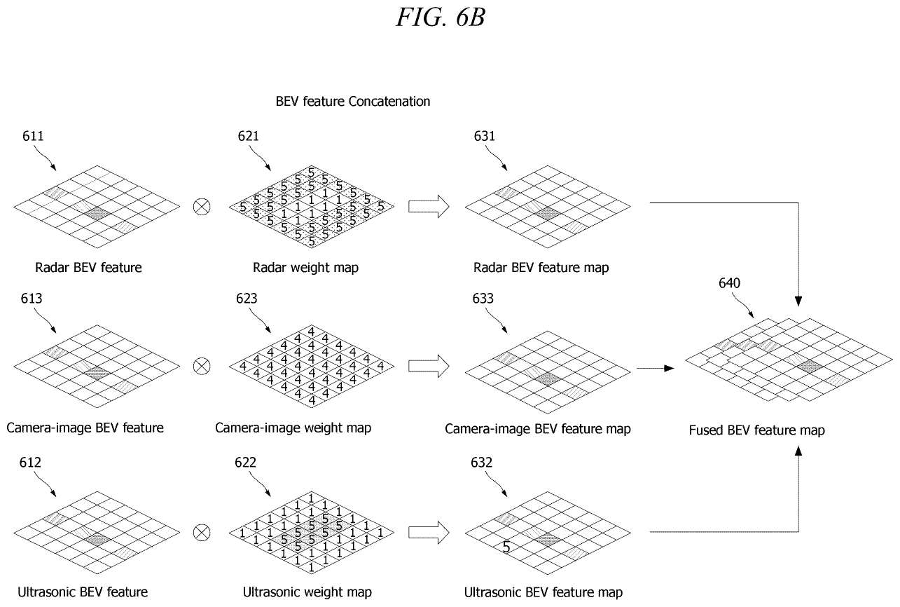

In consideration of this, the view transformation unit 410 may further include a camera view transformation unit 416. The camera view transformation unit 416 may receive depth information from the radar sensor 104c and the ultrasonic sensor 104d, reflect the received depth information to detect a three-dimensional object present in the image according to the LSS scheme, and apply the depth information of the object (e.g., depth priors for long-range radar or near-field ultrasonic, etc.). For example, as illustrated in FIG. 6A, the camera view transformation unit 416 receives radar feature information 601 from the radar feature information construction unit 411, and depth information provided from a sensor (for example, the radar sensor 104c) that has a wide recognition range and is capable of long-distance object recognition is used as radar-guided LSS to supplement the depth information estimated by the camera within a long-distance recognition range of 4 to 100 m. This makes it possible to improve the accuracy of object recognition in a driving situation (e.g., vehicle detection, cut-in prediction, or lane-change awareness, etc.).

Further, the camera view transformation unit 416 receives ultrasonic feature information 602 from the ultrasonic feature information construction unit 413, and depth information provided from a sensor (for example, the ultrasonic sensor 104d) having a narrow recognition range and capable of only short-range object recognition is used as an ultrasonic-guided LSS to supplement the depth information estimated by the camera within a short-range recognition range of 0.2 to 4 m. This makes it possible to improve the accuracy of the object recognition during low-speed driving or parking (e.g., curb detection, pole proximity, or garage maneuvering, etc.).

The radar BEV feature information 611, the ultrasonic BEV feature information 612, and the camera-image BEV feature information 613 may be generated by the configuration of the view transformation unit 410 described above (e.g., each as a top-down grid aligned to a common ego-centric frame, etc.).

The sensor fusion unit 420 may construct a distance-based weight map, apply the constructed weight map to each of the radar BEV feature information 611, the ultrasonic BEV feature information 612, and the camera-image BEV feature information 613 to construct BEV feature information maps, and fuse the constructed BEV feature information maps to construct a fused BEV feature information map (e.g., via weighted summation, learned convolutional fusion, or attention-based fusion, etc.).

For example, referring to FIG. 6B, which illustrates a fusion operation for the BEV feature information maps, the sensor fusion unit 420 may construct distance-based weight maps 621, 622, and 623. The distance-based weight maps 621, 622, and 623 may be constructed by reflecting characteristics of the sensor. For example, the sensor fusion unit 420 may construct a radar weight map 621 corresponding to the radar sensor 104c in consideration of the characteristics of the sensor illustrated in FIG. 5, and the radar weight map 621 may be constructed by assigning a relatively high weight to an area (4 to 100 m) that can be detected by the radar sensor 104c. For example, the radar weight map 621 may be constructed by reflecting a maximum weight value (for example, five) in pixels in the area (4 to 100 m) that can be detected by the radar sensor 104c and a minimum weight value (for example, one) to pixels in other areas (e.g., discrete bands per range interval or smoothly decaying weights, etc.).

Similarly, the sensor fusion unit 420 may construct an ultrasonic weight map 622 corresponding to the ultrasonic sensor 104d, and the ultrasonic weight map 622 may be constructed by assigning a relatively high weight to a short-range area (0.2 to 4 m) that can be detected by the ultrasonic sensor 104d. For example, the ultrasonic weight map 622 may be constructed by reflecting a maximum weight value (for example, five) in pixels in a short-range area (0.2 to 4 m) that can be detected by the ultrasonic sensor 104d and a minimum weight value (for example, one) in pixels in other areas (e.g., emphasizing near-field occupancy or contact risk, etc.).

Further, the sensor fusion unit 420 may construct a camera image weight map 623 in consideration of the characteristics of the camera 104a. For example, in the camera image weight map 623, the same weight may be assigned to the entire area and may be set to a value smaller than a maximum weight value of the weight assigned to the radar weight map 621 and the ultrasonic weight map 622 and greater than a minimum weight value (e.g., a mid-level constant to stabilize fusion against visual noise, etc.).

As described above, the sensor fusion unit 420 may apply the weight maps 621, 622, and 623 to the radar BEV feature information 611, the ultrasonic BEV feature information 612, and the camera-image BEV feature information 613 to construct the BEV feature information maps 631, 632, and 633, and fuse the constructed BEV feature information maps 631, 632, and 633 to construct and output a fused BEV feature information map 640 (e.g., supplied to detection heads, motion prediction, or trajectory planners, etc.).

Thus, the weight maps 621, 622, and 623 are reflected in the respective BEV feature information 611, 612, and 613 to construct the fused BEV feature information map 640, thereby making it possible to construct the feature information map while maintaining unique characteristics of different sensors and to improve object recognition performance in the feature information map even when information detected by the different sensors is fused (e.g., fewer false positives at long range, more reliable near-field obstacle cues, or improved multi-object tracking consistency, etc.).

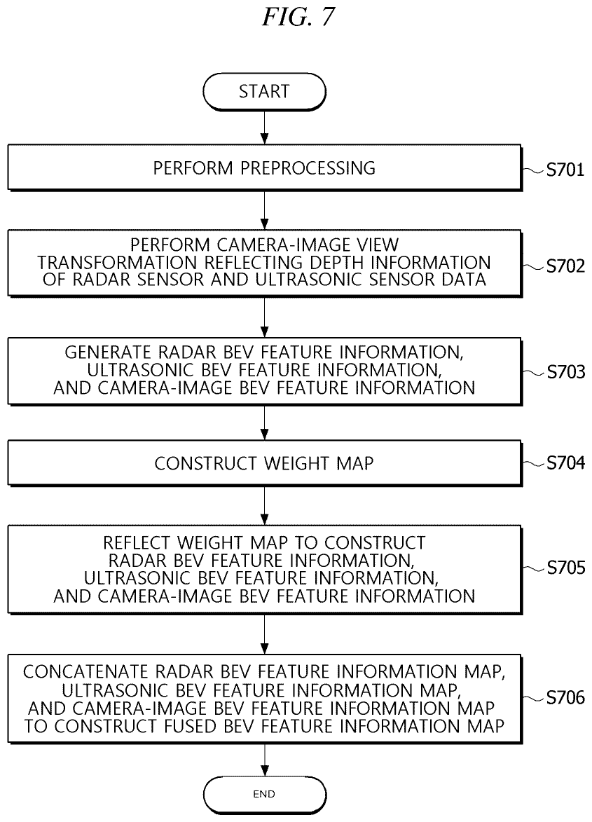

FIG. 7 shows an example of an operation of the distance-adaptive sensor fusion method according to an example of the present disclosure.

The distance-adaptive sensor fusion method according to the example of the present disclosure may be performed by the processor of the vehicle described above.

Referring to FIG. 7, the processor 610 may perform preprocessing on the radar signal input from the radar sensor, the ultrasonic signal input from the ultrasonic sensor, and the image signal input from the camera (S701) (e.g., denoising, normalization, or temporal alignment, etc.).

The processor 610 may preprocess the data input from the radar sensor 104c through noise filtering and then stack the filtered data along a time axis to sweep the filtered data and construct the radar feature information (e.g., CFAR detection, Doppler filtering, or tracklet formation, etc.).

Further, the processor 610 may preprocess data input from the ultrasonic sensor 104d by filtering a signal checked in a section in which a distance cannot be detected because the ROI is set to be relatively small, transform an input raw signal into a signal amplitude, and use the signal amplitude to construct the ultrasonic feature information (e.g., envelope detection, threshold gating, or echo peak picking, etc.).

Further, the processor 610 may encode and preprocess the image data input from the camera 104a, and then construct the camera-image feature information obtained by extracting the key features in the image using the deep learning-based feature extraction network such as ResNet or CNN (e.g., semantic masks, edge/texture pyramids, or keypoint descriptors, etc.).

Further, the processor 610 may perform synchronization on data (the radar feature information, the ultrasonic feature information, the camera-image feature information) preprocessed in the respective sensors based on timestamps (e.g., interpolation to nearest timestamp, PTP/IEEE-1588 alignment, or buffer time-windowing, etc.).

Next, the processor 610 may perform camera-image view transformation reflecting the depth information of the data from the radar sensor and ultrasonic sensor (S702) (e.g., Lift-Splat-Shoot projection to a BEV grid, etc.).

Specifically, the processor 610 may generate the camera-image BEV feature information using the camera-image feature information, but when a Lift, Splat, Shoot (LSS) scheme is used to generate the camera-image BEV feature information using the camera-image feature information, there is a problem that the accuracy of the depth value is low and the reliability of the camera-image BEV feature information is degraded because the depth distribution α is estimated using only the image (e.g., textureless surfaces, low light, or motion blur, etc.). In consideration of this, the processor 610 may receive depth information from the radar sensor 104c and the ultrasonic sensor 104d, reflect the received depth information to detect a three-dimensional object present in the image according to the LSS scheme, and apply the depth information of the object (e.g., radar-guided long-range priors and ultrasonic-guided near-field priors, etc.). For example, as illustrated in FIG. 6A, the processor 610 receives the radar feature information 601, and the depth information provided from a sensor (for example, the radar sensor 104c) that has a wide recognition range and is capable of long-distance object recognition is used as radar-guided LSS to supplement the depth information estimated by the camera within a long-distance recognition range of 4 to 100 m. This makes it possible to improve the accuracy of the object recognition in a driving situation (e.g., vehicle detection, cut-in prediction, or lane-change intent, etc.).

Further, the processor 610 receives the ultrasonic feature information 602, and the depth information provided from a sensor (for example, the ultrasonic sensor 104d) having a narrow recognition range and capable of only short-range object recognition is used as an ultrasonic-guided LSS to supplement the depth information estimated by the camera within a short-range recognition range of 0.2 to 4 m. This makes it possible to improve the accuracy of the object recognition during low-speed driving or parking (e.g., curb proximity, pole detection, or garage maneuvering, etc.).

Next, the processor 610 may generate the radar BEV feature information 611, the ultrasonic BEV feature information 612, and the camera-image BEV feature information 613 by using the radar feature information 601, the ultrasonic feature information 602, and the camera-image feature information 603, respectively (S703) (e.g., rasterizing features onto a common ego-centric grid, etc.).

Next, the processor 610 may construct the distance-based weight map (S704), and apply the constructed weight map to the radar BEV feature information 611, the ultrasonic BEV feature information 612, and the camera-image BEV feature information 613 to construct the BEV feature information maps 631, 632, and 633 (S705). For example, referring to FIG. 6B, which illustrates a fusion operation for the BEV feature information maps, the sensor fusion unit 420 may construct the distance-based weight maps 621, 622, and 623. The distance-based weight maps 621, 622, and 623 may be constructed by reflecting the characteristics of the sensor. For example, the sensor fusion unit 420 may construct the radar weight map 621 corresponding to the radar sensor 104c in consideration of the characteristics of the sensor illustrated in FIG. 5, and the radar weight map 621 may be constructed by assigning a relatively high weight to an area (4 to 100 m) that can be detected by the radar sensor 104c. For example, the radar weight map 621 may be constructed by reflecting the maximum weight value (for example, five) in the pixels in the area (4 to 100 m) that can be detected by the radar sensor 104c and the minimum weight value (for example, one) to the pixels in other areas (e.g., smoothly decaying weights or discrete bands per range interval, etc.). Similarly, the sensor fusion unit 420 may construct the ultrasonic weight map 622 corresponding to the ultrasonic sensor 104d, and the ultrasonic weight map 622 may be constructed by assigning a relatively high weight to a short-range area (0.2 to 4 m) that can be detected by the ultrasonic sensor 104d. For example, the ultrasonic weight map 622 may be constructed by reflecting a maximum weight value (for example, five) in pixels in a short-range area (0.2 to 4 m) that can be detected by the ultrasonic sensor 104d and a minimum weight value (for example, one) to pixels of other areas (e.g., emphasizing near-field occupancy and contact risk, etc.). Further, the sensor fusion unit 420 may construct the camera image weight map 623 in consideration of the characteristics of the camera 104a. For example, in the camera image weight map 623, the same weight may be assigned to the entire area and may be set to a value smaller than the maximum weight value of the weight assigned to the radar weight map 621 and the ultrasonic weight map 622 and greater than the minimum weight value thereof (e.g., a mid-level constant to stabilize fusion under visual noise, etc.).

Thereafter, the processor 610 may fuse the constructed BEV feature information maps 631, 632, and 633 to construct and output the fused BEV feature information map 640 (S706) (e.g., by weighted summation, learned convolutional fusion, or attention-based fusion, etc.).

Thus, the weight maps 621, 622, and 623 are reflected in the respective BEV feature information 611, 612, and 613 to construct the fused BEV feature information map 640, thereby making it possible to construct the feature information map while maintaining unique characteristics of different sensors and to improve object recognition performance in the feature information map even when information detected by the different sensors is fused (e.g., fewer long-range false positives, more reliable near-field obstacle cues, or improved multi-object tracking consistency, etc.).

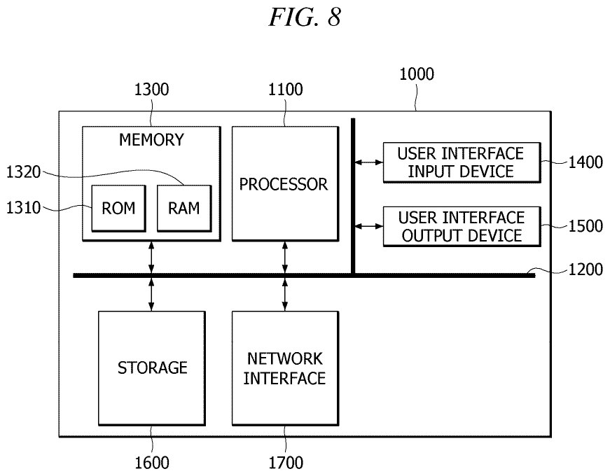

FIG. 8 shows an example computing system (e.g., a computing device of a vehicle or any other apparatus). One or more controllers, processors, etc. described herein, such as one or more components of the vehicle 100, one or more components of the server 200, one or more components of another vehicle 400, and any other components and devices disclosed herein, may be implemented by or in the computing system as shown in FIG. 8.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example example(s) disclosed in the specification may be implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

In accordance with another example of the present disclosure, there is provided a vehicle, the vehicle comprises: a sensor configured to detect a target object present near a host vehicle during autonomous driving; a memory configured to store a distance-adaptive sensor fusion program; and a processor configured to load the distance-adaptive sensor fusion program from the memory, wherein the processor is configured to execute the distance-adaptive sensor fusion program to: determine radar feature information using a radar signal input from a radar sensor; determine radar bird's-eye-view (BEV) feature information based on the radar feature information; determine ultrasonic feature information using an ultrasonic signal input from an ultrasonic sensor; determine ultrasonic BEV feature information based on the ultrasonic feature information; determine image feature information using image information input from a camera; reflect depth information of the radar feature information and the ultrasonic feature information in the image feature information in consideration of a detection area of the radar sensor and a detection area of the ultrasonic sensor, and perform view transformation on the image feature information; determine image BEV feature information based on the image feature information on which the view transformation is performed; and determine the radar BEV feature information, the ultrasonic BEV feature information, and the image BEV feature information to determine a fused BEV feature information map.

The processor may be configured to: determine a radar weight map obtained by assigning a weight to an area corresponding to the detection area of the radar sensor in consideration of the detection area of the radar sensor; determine an ultrasonic weight map obtained by assigning a weight to areas corresponding to the detection area of the ultrasonic sensor in consideration of the detection area of the ultrasonic sensor; and determine a camera image weight map obtained by assigning a weight to an area corresponding to a detection area of the camera in consideration of the detection area of the camera.

The processor may be configured to: reflect a radar weight map obtained by assigning a weight to an area corresponding to the detection area of the radar sensor in the radar BEV feature information to determine a radar BEV feature information map; reflect a camera image weight map obtained by assigning a weight to an area corresponding to a detection area of the camera in the image BEV feature information to determine an image BEV feature information map; reflect an ultrasonic weight map obtained by assigning a weight to areas corresponding to the detection area of the ultrasonic sensor in the ultrasonic BEV feature information to determine an ultrasonic radar BEV feature information map; and concatenate the radar BEV feature information map, the image BEV feature information map, and the ultrasonic radar BEV feature information map to determine the fused BEV feature information map.

The processor may be configured to: assign a maximum weight value to an area in which there are pixels included in a detection area of the radar sensor, and assign a minimum weight value to an area in which there are pixels not included in the detection area of the radar sensor to determine the radar weight map, and assign a maximum weight value to an area in which there are pixels included in a detection area of the ultrasonic sensor and a minimum weight value to an area in which there are pixels not included in the detection area of the ultrasonic sensor, to determine the ultrasonic weight map.

The processor may be configured to: assign a weight value smaller than the maximum weight value and greater than the minimum weight value to an area in which there are pixels included in a detection area of the camera, to determine the camera image weight map.

The detection area of the radar sensor may be set to an area of 4 meter or more and less than 100 meter from an outer surface of a host vehicle, the detection area of the ultrasonic sensor may be set to an area of 0.2 meter or more and less than 4 meter from the outer surface of the host vehicle, and the detection area of the camera may be set to an area of 4 meter or more and less than 15 meter from the outer surface of the host vehicle.

In accordance with another example of the present disclosure, there is provided a non-transitory computer-readable storage medium including computer executable instructions, wherein the instructions, when executed by a processor, cause the processor to perform distance-adaptive sensor fusion method, the method comprise: determining radar feature information using a radar signal input from a radar sensor; determining radar bird's-eye-view (BEV) feature information based on the radar feature information; determining ultrasonic feature information using an ultrasonic signal input from an ultrasonic sensor; determining ultrasonic BEV feature information based on the ultrasonic feature information; determining image feature information using image information input from a camera; reflecting depth information of the radar feature information and the ultrasonic feature information in the image feature information in consideration of a detection area of the radar sensor and a detection area of the ultrasonic sensor, and performing view transformation on the image feature information; determining image BEV feature information based on the image feature information on which the view transformation is performed; and concatenating the radar BEV feature information, the ultrasonic BEV feature information, and the image BEV feature information to determine a fused BEV feature information map.

According to the disclosed disclosure, it is possible to improve the performance in detection of an object from an image by reflecting depth information of data from an ultrasonic sensor and a radar sensor in a camera image.

Further, according to the disclosed disclosure, it is possible to maximize the performance in object recognition according to a situation by reflecting a weight map considering detection areas of an ultrasonic sensor and a radar sensor in detection of an object in an image.

According to the disclosed disclosure, it is possible to improve the performance in detection of an object from an image by reflecting depth information of data from an ultrasonic sensor and a radar sensor in a camera image.

Further, according to the disclosed disclosure, it is possible to maximize the performance in object recognition according to a situation by reflecting a weight map considering detection areas of an ultrasonic sensor and a radar sensor in detection of an object in an image.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative examples, the functions mentioned in the steps may occur out of order. For example, two steps illustrated in succession may in fact be performed simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the examples disclosed in the present disclosure are intended to explain, not to limit, the technical scope of the present disclosure, and the technical scope of the present disclosure is not limited by the examples. The protection scope of the present disclosure should be interpreted based on the following claims and it should be appreciated that all technical scopes included within a range equivalent thereto are included in the protection scope of the present disclosure.

What is claimed is:

1. A method performed by a vehicle, the method comprising:
obtaining radar feature information using a radar signal input from a radar sensor of the vehicle;
determining radar bird's-eye-view (BEV) feature information based on the radar feature information;
obtaining ultrasonic feature information using an ultrasonic signal input from an ultrasonic sensor of the vehicle;
determining ultrasonic BEV feature information based on the ultrasonic feature information;
obtaining image feature information using image data captured from a camera of the vehicle;
updating the image feature information based on first depth information associated with a first detection area of the radar sensor and second depth information associated with a second detection area of the ultrasonic sensor;
performing view transformation on the updated image feature information;
determining image BEV feature information based on the view-transformed image feature information;
outputting a signal indicating detected objects based on fusion of the radar BEV feature information, the ultrasonic BEV feature information, and the image BEV feature information; and
controlling, based on the signal, an operation of the vehicle.

2. The method of claim 1, wherein the outputting of the signal indicating the detected objects comprises:
determining a radar weight map by assigning, to regions within the first detection area, a first weight higher than weights assigned to regions outside the first detection area;
determining an ultrasonic weight map by assigning, to regions within the second detection area, a second weight higher than weights assigned to regions outside the second detection area; and
determining a camera image weight map by assigning, to regions within a third detection area of the camera, a uniform weight having a value between the first weight and the second weight,
wherein the signal indicating the detected objects comprises a signal indicating a fused BEV feature information map.

3. The method of claim 1, wherein the outputting of the signal indicating the detected objects comprises:
generating a radar weight map by assigning a weight to the first detection area of the radar sensor;
adjusting, based on the radar weight map, weight values of portions of the radar BEV feature information associated with the first detection area;
determining, based on the adjusted weight values of portions of the radar BEV feature information, a radar BEV feature information map;
generating an image weight map by assigning a weight to a third detection area of the camera;
adjusting, based on the image weight map, weight values of portions of the image BEV feature information associated with the third detection area;
determining, based on the adjusted weight values of portions of the image BEV feature information, an image BEV feature information map;
generating an ultrasonic weight map by assigning a weight to the second detection area of the ultrasonic sensor;
adjusting, based on the ultrasonic weight map, weight values of portions of the ultrasonic BEV feature information associated with the second detection area,
determining, based on the adjusted weight values of portions of the ultrasonic BEV feature information, an ultrasonic BEV feature information map; and
based on fusion of the radar BEV feature information map, the image BEV feature information map, and the ultrasonic BEV feature information map, determining a fused BEV feature information map.

4. The method of claim 2, wherein the determining of the radar weight map comprises:
assigning a maximum weight value to pixels included in the first detection area of the radar sensor; and
assigning a minimum weight value to pixels outside the first detection area of the radar sensor, and
wherein the determining of the ultrasonic weight map comprises:
assigning a maximum weight value to pixels included in the second detection area of the ultrasonic sensor; and
assigning a minimum weight value to pixels outside the second detection area of the ultrasonic sensor.

5. The method of claim 2, wherein the determining of the camera image weight map comprises assigning a weight value smaller than a maximum weight value and greater than a minimum weight value to pixels included in the third detection area of the camera.

6. The method of claim 1,
wherein the first detection area of the radar sensor is defined as a region extending 4 meters to less than 100 meters from an outer surface of the vehicle,
the second detection area of the ultrasonic sensor is defined as a region extending 0.2 meters to less than 4 meters from the outer surface of the vehicle, and
a third detection area of the camera is defined as a region extending 4 meters to less than 15 meters from the outer surface of the vehicle.

7. A vehicle comprising:
at least one sensor configured to detect a target object present within a preset threshold distance from the vehicle during autonomous driving of the vehicle;
a processor; and
a memory storing at least one instruction that, when executed by the processor, is configured to cause the vehicle to:
obtain radar feature information using a radar signal input from a radar sensor of the at least one sensor,
determine radar bird's-eye-view (BEV) feature information based on the radar feature information,
obtain ultrasonic feature information using an ultrasonic signal input from an ultrasonic sensor of the at least one sensor,
determine ultrasonic BEV feature information based on the ultrasonic feature information,
obtain image feature information using image data captured from an image sensor of the at least one sensor,
update the image feature information based on first depth information associated with a first detection area of the radar sensor and second depth information associated with a second detection area of the ultrasonic sensor,
perform view transformation on the updated image feature information,
determine image BEV feature information based on the view-transformed image feature information,
output a signal indicating detected objects based on fusion of the radar BEV feature information, the ultrasonic BEV feature information, and the image BEV feature information, and
control, based on the signal, an operation of the vehicle.

8. The vehicle of claim 7, wherein the at least one instruction, when executed by the processor, is configured to cause the vehicle to:
determine a radar weight map by assigning, to regions within the first detection area, a first weight higher than weights assigned to regions outside the first detection area,
determine an ultrasonic weight map by assigning, to regions within the second detection area, a second weight higher than weights assigned to regions outside the second detection area, and
determine an image weight map by assigning, to regions within a third detection area of the image sensor, a uniform weight having a value between the first weight and the second weight.

9. The vehicle of claim 7, wherein the at least one instruction, when executed by the processor, is configured to cause the vehicle to:
generate a radar weight map by assigning a weight to the first detection area of the radar sensor,
adjust, based on the radar weight map, weight values of portions of the radar BEV feature information associated with the first detection area,
determine, based on the adjusted weight values of portions of the radar BEV feature information, a radar BEV feature information map,
generate an image weight map by assigning a weight to a third detection area of the image sensor,
adjust, based on the image weight map, weight values of portions of the image BEV feature information associated with the third detection area,
determine, based on the adjusted weight values of portions of the image BEV feature information, an image BEV feature information map,
generate an ultrasonic weight map by assigning a weight to the second detection area of the ultrasonic sensor,
adjust, based on the ultrasonic weight map, weight values of portions of the ultrasonic BEV feature information associated with the second detection area,
determine, based on the adjusted weight values of portions of the ultrasonic BEV feature information, an ultrasonic BEV feature information map,
determine a fused BEV feature information map based on fusion of the radar BEV feature information map, the image BEV feature information map, and the ultrasonic BEV feature information map.

10. The vehicle of claim 7, wherein the at least one instruction, when executed by the processor, is configured to cause the vehicle to:
determine a radar weight map by assigning a maximum weight value to pixels included in the first detection area of the radar sensor and by assigning a minimum weight value to pixels outside the first detection area of the radar sensor, and
determine an ultrasonic weight map by assigning a maximum weight value to pixels included in the second detection area of the ultrasonic sensor and by assigning a minimum weight value to pixels outside the second detection area of the ultrasonic sensor.

11. The vehicle of claim 7, wherein the at least one instruction, when executed by the processor, is configured to cause the vehicle to determine an image weight map by assigning a weight value smaller than a maximum weight value and greater than a minimum weight value to pixels included in a third detection area of the image sensor.

12. The vehicle of claim 8, wherein:
the first detection area of the radar sensor is defined as a region located farther from an outer surface of the vehicle than the second detection area of the ultrasonic sensor, and
the third detection area of the image sensor is defined as a region overlapping at least partially with the first detection area.

13. A vehicle comprising:
a plurality of sensors configured to capture sensor data associated with a surrounding environment of the vehicle, wherein the plurality of sensors comprises:
a radar sensor configured to detect objects within a first detection area,
an ultrasonic sensor configured to detect objects within a second detection area, and
a camera configured to capture image data within a third detection area;
a driving control circuit configured to control autonomous driving of the vehicle; and
a processor circuit configured to cause the vehicle to:
obtain radar feature information based on a radar signal of the radar sensor, obtain ultrasonic feature information based on an ultrasonic signal of the ultrasonic sensor, and obtain camera-image feature information based on the image data of the camera, and
generate radar bird's-eye-view (BEV) feature information based on the radar feature information, generate ultrasonic BEV feature information based on the ultrasonic feature information, and generate camera-image BEV feature information based on the camera-image feature information, and
determine a radar weight map, an ultrasonic weight map, and a camera-image weight map respectively corresponding to the radar sensor, the ultrasonic sensor, and the camera, wherein the radar weight map assigns a first weight to a region corresponding to the first detection area, wherein the ultrasonic weight map assigns a second weight to a region corresponding to the second detection area, and wherein the camera-image weight map assigns a uniform weight to a region corresponding to the third detection area,
generate weighted BEV feature information based on applying the radar weight map, the ultrasonic weight map, and the camera-image weight map, respectively, to the radar BEV feature information, the ultrasonic BEV feature information, and the camera-image BEV feature information,
output, based on the weighted BEV feature information, a signal indicating detected objects in the surrounding environment of the vehicle, and
control, via the driving control circuit and based on the signal, autonomous driving of the vehicle.

14. The vehicle of claim 13, wherein the processor circuit is configured to cause the vehicle to adjust depth information of the camera-image BEV feature information by using depth information derived from the radar feature information and the ultrasonic feature information prior to generating the weighted BEV feature information.

15. The vehicle of claim 13, wherein the processor circuit is configured to cause the vehicle to:
define the first detection area of the radar sensor as a region located farther from an outer surface of the vehicle than the second detection area of the ultrasonic sensor, and
define the third detection area of the camera as a region overlapping at least partially with the first detection area and the second detection area.

16. The vehicle of claim 13, wherein the processor circuit is configured to cause the vehicle to:
construct the radar weight map such that regions farther from the vehicle are assigned greater weights than regions closer to the vehicle, and
construct the ultrasonic weight map such that regions closer to the vehicle are assigned greater weights than regions farther from the vehicle.

17. The vehicle of claim 13, wherein the processor circuit is configured to define:
the first detection area of the radar sensor as a predetermined first distance range extending from an outer surface of the vehicle,
the second detection area of the ultrasonic sensor as a predetermined second distance range extending from the outer surface of the vehicle, the predetermined second distance range being shorter than the predetermined first distance range, and
the third detection area of the camera as a predetermined third distance range extending from the outer surface of the vehicle and overlapping at least in part with the predetermined first distance range.

18. The vehicle of claim 13, wherein the processor circuit is configured to cause the vehicle to generate, based on fusion of the radar BEV feature information, the ultrasonic BEV feature information, and the camera-image BEV feature information, a fused BEV feature information map, wherein the fused BEV feature information map represents the surrounding environment of the vehicle.

19. The vehicle of claim 13, wherein the processor circuit is configured to cause the vehicle to detect, based on fusion of the radar BEV feature information, the ultrasonic BEV feature information, and the camera-image BEV feature information, at least one object within the second detection area and output a control signal for short-range braking or parking assistance.

20. The vehicle of claim 13, wherein the processor circuit is configured to cause the vehicle to update a planned driving trajectory based on detection of a nearby vehicle within the first detection area.
